(19) United States
(12) Patent Application Publication
(10) Pub. No.: US 2012/0272476 A1
(43) Pub. Date: Nov. 1, 2012

(54) RAMPED SASH CAM FOR SIDE LOAD WINDOWS

(76) Inventors: Chad Swier, Sioux Falls, SD (US); Gene A. Van Voorst, Inwood, IA (US); Jake Buell, Laguna Niguel, CA (US)

(21) Appl. No.: 13/094,446

(22) Filed: Apr. 26, 2011

(51) Int. Cl. E05D 13/00; E06B 7/00

(52) U.S. Cl. 16/193; 16/404

(57) ABSTRACT

A sash cam includes a body adapted to be secured to a window sash. The body has an angled interface surface adapted to contact a top guide of a window balance.

Hung window assemblies generally include a window frame, a lower window sash, an upper window sash, a pair of window jambs, two sets of jamb channels, and at least one window balance device for offsetting the weight of a window sash throughout a range of travel within the window frame. Window balance devices use springs, pulleys, or a combination thereof to balance the weight of the window sash at any position within the jamb channels. In some cases, the springs and pulleys are located within channels or housings that travel with the window sash as it is raised and lowered.

In some window balance devices, most notably block and tackle window balance devices, the channel containing the spring and pulleys is attached to the window sash, and a cord, which connects the pulleys together, is attached to a jamb mounting hook that is connected to a side jamb. One or both of upper and lower sash cams are secured to the sides of a moveable window sash and interact with the top and bottom guides of the window balance respectively. These interacting components, referred to herein as interfaces, engage the window sash with the window balance as the window is raised and lowered.

A prior art window balance upper interface 10 is depicted in FIG. 1. The upper interface 10 is the area of engagement between a window balance 12 and an upper portion of a window sash 14. The window balance 12 is moveable within a jamb pocket 16 and includes a balance channel 18 and a top guide 20. The top guide 20 includes a sliding surface 22 that slides against a rear wall 24 of the jamb channel 16. The top guide 20 also includes a projection 26 proximate a front face of the top guide 20. A sash cam 28 is secured to the window sash 14 at a sash-contacting surface 30. Fasteners such as screws, bolts, chemical adhesives or a combination of these or other appropriate devices may be utilized to secure the sash cam 28 to the window sash 14. The sash cam 28 also includes an interface surface 32 for engaging the projection 26 on the top guide 20. The interface surface 32 generally rests on the projection 26 as a balance force F biases the balance upward within the jamb channel 16, thus holding the window sash 14 in any position as the window sash 14 is raised and lowered. A second upper interface is located on the opposite side of the window sash 14 and includes a similar window balance and sash cam secured to the window sash 14. With existing interfaces 10, there is often play P between the top of the window sash 14 and the top guide 20, as the sash cam surface 32 slides against the projection 26. This play P decreases the stability of the window sash 14, which may cause the window sash 14 to slide unevenly, leading to unwanted friction and improper operation.

### SUMMARY

In one aspect, the technology relates to a sash cam having a body adapted to be secured to a window sash, the body including an angled interface surface adapted to contact a top guide of a window balance. In an embodiment of the above aspect, the body includes a sash-contacting surface for contacting the window sash, and wherein the angled interface surface is oriented at an angle to the sash-contacting surface. In another embodiment, the angle is from about 85 degrees to about 15 degrees, from about 70 degrees to about 25 degrees, or from about 65 degrees to about 55 degrees. In another embodiment, the angled interface surface is adapted to contact a projection on the top guide.

In another aspect, the technology relates to a window balance system for a window sash, the window balance system including: a window balance having a balance channel and a top guide connected to the balance channel; and a sash cam having a sash-contacting surface and an angled interface surface, wherein the sash-contacting surface is adapted to be secured to the window sash and the angled interface surface is adapted to contact the top guide. In an embodiment, the angled interface surface is oriented at an angle to the sash-contacting surface. In certain embodiments, the angle is from about 85 degrees to about 15 degrees, from about 70 degrees to about 25 degrees, or from about 65 degrees to about 55 degrees.

### BRIEF DESCRIPTION OF THE DRAWINGS

There are shown in the drawings, embodiments which are presently preferred, it being understood, however, that the technology is not limited to the precise arrangements and instrumentalities shown.

FIG. 1 is a side view of a prior art window balance upper interface.

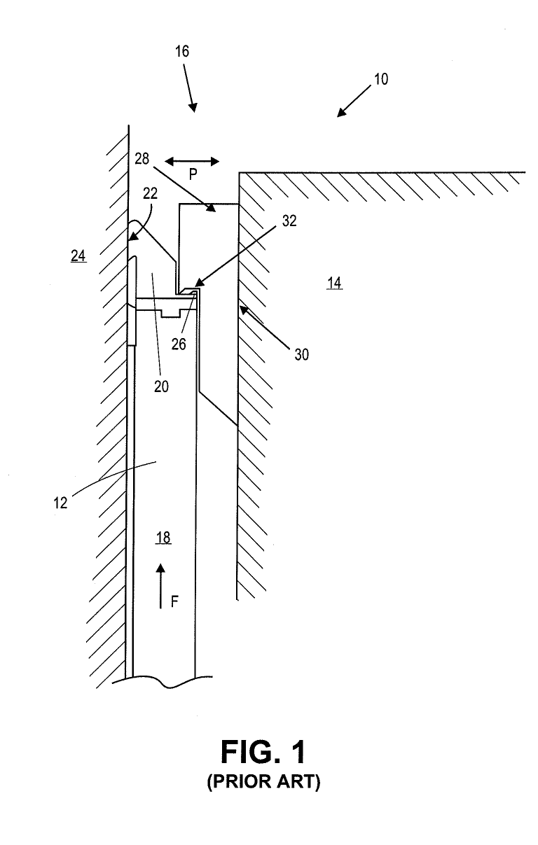

FIG. 2 is a side view of a window balance upper interface.

FIG. 3 is a side view of a sash cam.

FIG. 4 is a perspective view of a sash cam.

### DETAILED DESCRIPTION

The description that follows utilizes a block and tackle window balance as an exemplary embodiment of a window balance device that may benefit from the technology described herein. Ramped sash cams such as those described, may also be used on other types of window balance devices to center the window sash in the window frame and eliminate play or slop of the sash. Other such balance devices include constant force balance devices, spiral balance devices, and balances that utilize a combination of balance technologies (for example, those that utilize both block and tackle and spiral balance technology). Additionally, the examples provided herein depict ramped sash cam technology utilized near a top of a window sash, engaging an upper portion of a window sash. It is also contemplated to utilize the technology described herein proximate a bottom portion of a window sash, or elsewhere along the length of the sash, as required or desired for a particular application.

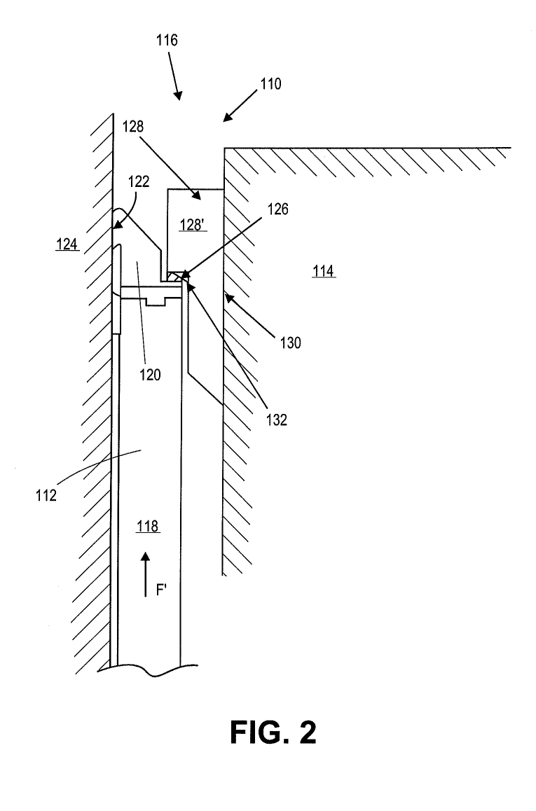

FIG. 2 depicts a side view of a window balance upper interface 110 in accordance with the present technology. In the depicted embodiment, a window sash 114 is configured to move within a window frame. The frame forms a jamb channel 116, in which a window balance 112 slides vertically. The window balance 112 includes a balance channel 118 and a top guide 120. As described above with regard to the prior art, the top guide 120 may include a sliding surface 122 that slides against a rear wall 124 of the jamb channel 116. The top guide 120 also includes a projection 126 proximate a front face of the top guide 120. A spring located within the balance channel 118 creates an upward force F′ on the balance channel 118 and, by extension, the window sash 114.

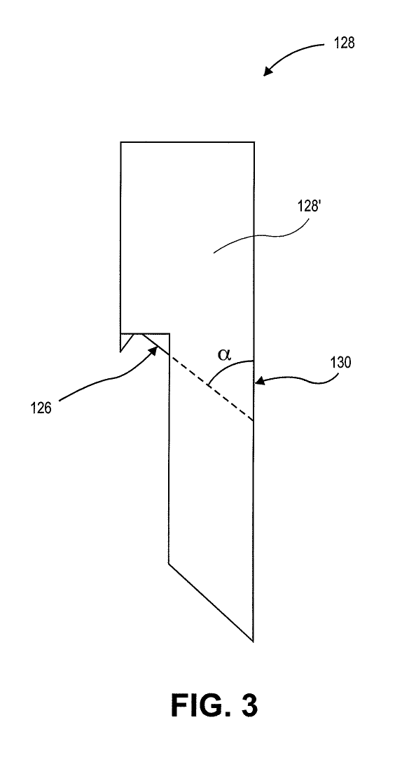

A ramped sash cam 128 is secured to the window sash 114 and includes a body 128′ and a sash-contacting surface 130 that contacts the sash 114 when the cam 128 is secured thereto. The ramped sash cam 128 includes an angled interface surface 132. The angled interface surface 132 is oriented at an angle a to the sash-contacting surface 130, as depicted in FIG. 3. Since a sash cam is installed on each side of a window sash, the interaction between each angled interface surface and their respective top guides forces the window sash away from each window balance. With a top guide and angled interface surface on both sides of the window sash, the sash is balanced between the two top guides, thus holding the window sash in place while reducing or eliminating play at the upper interface. The angle a helps seat the window sash evenly within the window frame. The angle a may be between about 85 degrees and about 15 degrees, or between about 70 degrees and about 25 degrees, or between about 65 degrees and about 55 degrees. If the angle a is too steep, the seating force exerted by the window sash against the window balances may force the sash against the rear wall of the jamb channel, causing excess friction during sliding. If this force is excessive, the window balances may become jammed in place, preventing operation of the window.

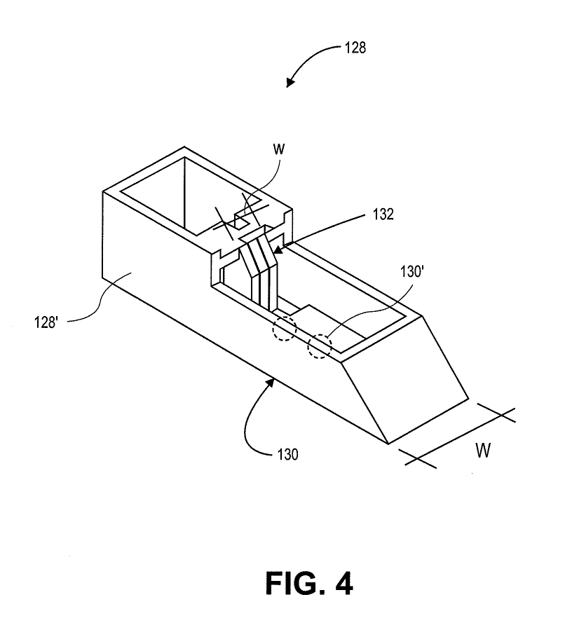

FIG. 4 depicts a perspective view of a ramped sash cam 128 as described herein. The sash cam 128 includes a body 128′, which may be solid or hollow, as required or desired for a particular application. The sash-contacting surface 130 is located on a rear wall of the body 128′. The rear wall of the body 128′ may also define one or more openings 130′ for passage of fasteners, such as screws or bolts, for securing the ramped sash cam 128 to the window sash. In the case of a solid body, the openings 130′ may be formed as bores through the entire body. The angled interface surface 132 may comprise a plurality of surfaces separated by a plurality of gaps, as depicted in FIG. 4. Reducing the total area of the angled interface surface 132 may help eliminate friction between the angled interface surface 132 and the projection 126 at the point of contact. The body 128′ defines dimensions that allow the ramped sash cam 128 to be used with an appropriately-sized top guide. In general, the width w of the angled interface surface 132 is less than the width W of the body 128′.

The materials utilized in the manufacture of the ramped sash cam may be those typically utilized for window balance manufacture, e.g., aluminum, zinc, steel, brass, stainless steel, or plastic (such as PVC, polyethylene, nylon, acetal, etc.). Material selection for most of the components may be based on the proposed use of the ramped sash cam. Appropriate materials may be selected for cams subject to certain environmental conditions (e.g., moisture, corrosive atmospheres, etc.).

Although a single top guide/sash cam interface is depicted in the figures, it should be understood that a typical window installation would include one interface on each side of a window sash. Certain window embodiments may benefit from a single ramped sash cam on one side of the sash and a second, standard, sash cam on the opposite side. It is likely, however, that the window sash may not sit properly between the window balances if only a single ramped sash cam is used. In certain applications, however, this may be acceptable. Additionally, although the ramped sash cam is depicted as a discrete structure that is secured to a side of a window sash, it is contemplated that certain window sashes may be manufactured with an angled interface surface integral with the window sash. Another embodiment of the ramped sash cam disclosed herein includes a structure having a side configuration such as that depicted in FIG. 3. Unlike the embodiment depicted in FIG. 4, however, the ramped sash cam may be a cut, stamped, or otherwise machined or formed piece of metal or plastic, having a minimal width W dimension. In such a case, the width w of the angled interface surface 132 may be equal to the width W of the body 128′.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A sash cam comprising a body adapted to be secured to a window sash, the body comprising an angled interface surface adapted to contact a top guide of a window balance.

2. The sash cam of claim 1, wherein the body further comprises a sash-contacting surface for contacting the window sash, and wherein the angled interface surface is oriented at an angle to the sash-contacting surface.

3. The sash cam of claim 2, wherein the angle comprises an angle from about 85 degrees to about 15 degrees.

4. The sash cam of claim 3, wherein the angle comprises an angle from about 70 degrees to about 25 degrees.

5. The sash cam of claim 4, wherein the angle comprises an angle from about 65 degrees to about 55 degrees.

6. The sash cam of claim 1, wherein the angled interface surface is adapted to contact a projection on the top guide.

7. A window balance system for a window sash, the window balance system comprising:
a window balance comprising a balance channel and a top guide connected to the balance channel; and
a sash cam comprising a sash-contacting surface and an angled interface surface, wherein the sash-contacting surface is adapted to be secured to the window sash and the angled interface surface is adapted to contact the top guide.

8. The window balance system of claim 7, wherein the angled interface surface is oriented at an angle to the sash-contacting surface.

9. The window balance system of claim 8, wherein the angle comprises an angle from about 85 degrees to about 15 degrees.

10. The window balance system of claim 9, wherein the angle comprises an angle from about 70 degrees to about 25 degrees.

11. The window balance system of claim 10, wherein the angle comprises an angle from about 65 degrees to about 55 degrees.
